(19) United States
(12) Patent Application Publication
(10) Pub. No.: US 2017/0037821 A1
(43) Pub. Date: Feb. 9, 2017

(54) FUEL SYSTEM HAVING FILTER ASSEMBLY WITH VALVE COVER

(71) Applicant: Electro-Motive Diesel, Inc., LaGrange, IL (US)

(72) Inventors: Timothy Joseph PAULSON, Schererville, IN (US); Michael Anthony BLOOME, Melrose Park, IL (US)

(73) Assignee: Electro-Motive Diesel, Inc., LaGrange, IL (US)

(21) Appl. No.: 14/818,942

(22) Filed: Aug. 5, 2015

(51) Int. Cl. F02M 37/00; B01D 35/143; B01D 35/00; B01D 35/147

(52) U.S. Cl. CPC F02M 37/0076; B01D 35/147; B01D 35/143; B01D 35/005

(57) ABSTRACT

A filter assembly is disclosed for use with a fuel system. The filter assembly may have a base with a first side, and a second side opposite the first side. The filter assembly may also have a filter extending from the first side of the base, a valve extending from the second side of the base, and a metallic cover having a closed end surrounding the valve and an open end located adjacent the second side of the base. The filter assembly may further have a seal sandwiched between the metallic cover and the base, a retainer connected to the base and extending over the metallic cover, and a fastener threadingly engaged with the retainer and protruding inward to press the metallic cover toward the base.

### TECHNICAL FIELD

The present disclosure relates generally to a fuel system and, more particularly, to a fuel system having a filter assembly with a valve cover.

### BACKGROUND

A typical fuel system includes a pump that draws fuel from a tank, pressurizes the fuel, and directs the pressurized fuel through a supply passage and filter to one or more fuel injectors. A first check valve is disposed within a return line that extends from the fuel injectors back to the tank, and a second check valve is disposed in parallel with the filter. In order for the fuel system to function properly, the system should be generally free of air and free of undue flow restrictions (e.g., restrictions caused by plugging of the filter).

Historically, the air-free and restriction-free status of a fuel system was confirmed by way of one or more sight-glasses plumbed in-line with the first and second check valves. For example, a first sight-glass was associated with the first check valve and used to determine that the supply and return passages were free of air, while a second sight-glass was associated with the second check valve and used to determine that the filters were not clogged. In particular, when the first sight-glass was full of fuel, it could be concluded that the supply and return passages were generally air-free. And as long as the second sight-glass was empty of fuel, it could be concluded that the filter was creating little restriction on the fuel flow. Such a system is disclosed in a maintenance manual entitled “645E BLOWER-TYPE ENGINE MAINTENANCE MANUAL”, 5^{th} edition, which was published in January 1980.

A conventional sight-glass includes a transparent glass bowl that is inverted, having its rim pressed against a cast filter base. A gasket or other seal is sandwiched between the rim of the glass bowl and a machined face of the base. An arcuate bracket extends from the base at one side of the glass bowl over the closed end of the glass bowl to an opposing side. A bolt is threadingly engaged with the bracket at a center of the glass bowl, and is adjustable to press the center downward toward the rim. This downward pressing functions to urge the rim of the glass bowl against the gasket, thereby sealing the sight-glass against the base.

Although the use of a sight-glass may be effective in determining the status of a fuel system, the sight-glass can also be problematic. In particular, the sight-glass (e.g., the glass bowl and/or the arcuate bracket holding the glass bowl) is subject to extreme vibration in some applications. These vibrations, if not accounted for, can cause the glass bowl and/or the arcuate bracket to fail.

The disclosed fuel system and filter assembly are directed to overcoming one or more of the problems set forth above and/or other problems of the prior art.

### SUMMARY

In one aspect, the present disclosure is directed to a filter assembly for a fuel system. The filter assembly may include a base with a first side, and a second side opposite the first side. The filter assembly may also include a filter extending from the first side of the base, a valve extending from the second side of the base, and a metallic cover having a closed end surrounding the valve and an open end located adjacent the second side of the base. The filter assembly may further include a seal sandwiched between the metallic cover and the base, a retainer connected to the base and extending over the metallic cover, and a fastener threadingly engaged with the retainer and protruding inward to press the metallic cover toward the base.

In another aspect, the present disclosure is directed to another filter assembly for a fuel system. This filter assembly may include a base having a first side and a second side opposite the first side, a filter extending from the first side of the base, and a valve extending from the second side of the base. The filter assembly may also include a cover having a closed end surrounding the valve and an open end located adjacent the second side of the base, and a seal sandwiched between the metallic cover and the base. The filter assembly may further include a retainer having first and second sides connected to the base, and a third side extending over the cover between the first and second sides. The first, second, and third sides may form a generally C-shaped channel. The filter assembly may additionally include a fastener threadingly engaged with the third side of the retainer and protruding inward to press the cover toward the base.

In yet another aspect, the present disclosure is directed to a fuel system. The fuel system may include a tank, a pump connected to draw fuel from the tank, a plurality of fuel injectors, and a manifold connecting the pump to the plurality of fuel injectors. The fuel system may also include a filter assembly disposed between the pump and the manifold. The filter assembly may have a base with a first side and a second side opposite the first side, a filter extending from the first side of the base, a first valve extending from the second side of the base, and a second valve located adjacent the first valve and extending from the second side of the base. The fitter assembly may additionally have a first metallic cover with a closed end surrounding the first valve and an open end located adjacent the second side of the base, and a second metallic cover with a closed end surrounding the second valve and an open end located adjacent the second side of the base. The filter assembly may further have a seal sandwiched between each of the first and second metallic covers and the base; and a first retainer with first and second sides connected to the base, and a third side extending over the first metallic cover between the first and second sides. The first, second, and third sides of the first retainer may form a first generally C-shaped channel. The filter assembly may also have a second retainer with first and second sides connected to the base, and a third side extending over the second metallic cover between the first and second sides. The first, second, and third sides of the second retainer may form a second generally C-shaped channel. The filter assembly may further have a first fastener threadingly engaged with the third side of the first retainer and protruding inward to press the first metallic cover toward the base, a second fastener threadingly engaged with the third side of the second retainer and protruding inward to press the second metallic cover toward the base, and a safety wire passing through a head of at least one of the first and second fasteners to inhibit loosening of the at least one of the first and second fasteners. The first and second metallic covers may each include a lip located at the open end to engage the seal and having a circular-lay roughness of about 125 μinch.

### BRIEF DESCRIPTION OF THE DRAWING

FIG. 1 is a diagrammatic and schematic illustration of an engine having an exemplary disclosed fuel system;

FIG. 2 is a cross-sectional illustration of an exemplary disclosed filter assembly that may be used in conjunction with the fuel system of FIG. 1; and

FIGS. 3 and 4 are isometric illustrations of exemplary filter assembly embodiments.

### DETAILED DESCRIPTION

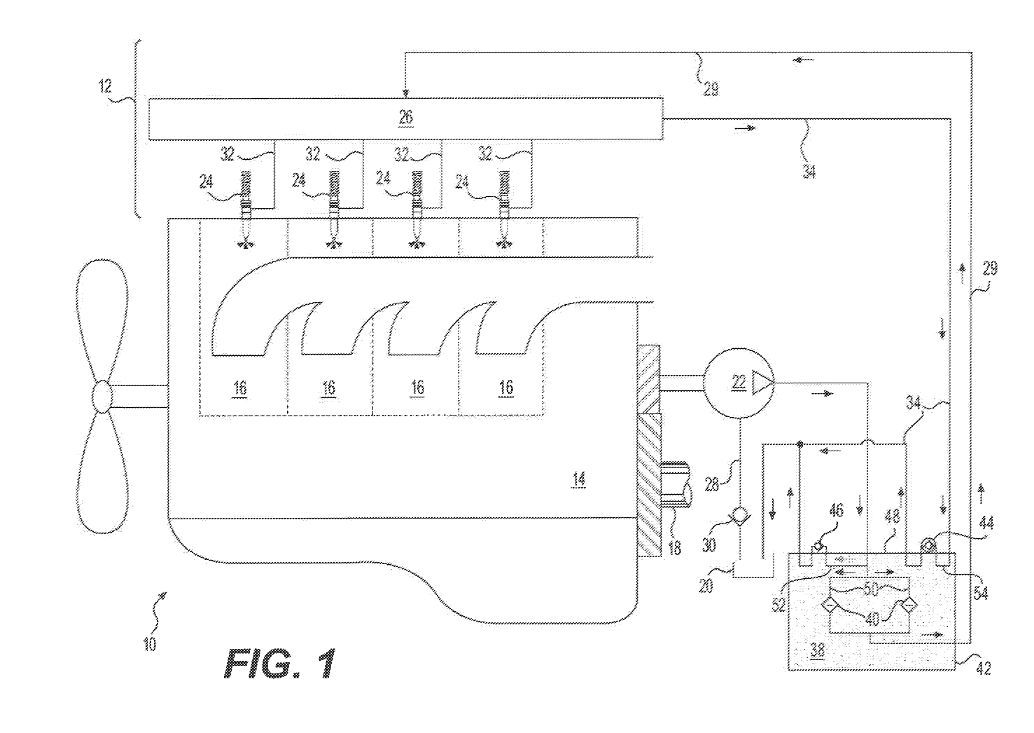

FIG. 1 illustrates an engine equipped with having a fuel system 12. For the purposes of this disclosure, engine 10 is depicted and described as being a four-stroke diesel engine. One skilled in the art will recognize, however, that engine 10 may embody any other type of internal combustion engine such as, for example, a two-stroke diesel, gasoline, or gaseous fuel-powered engine. Engine 10 may include a block 14 that at least partially defines a plurality of combustion chambers 16. In the illustrated embodiment, engine 10 includes four combustion chambers 16. However, it is contemplated that engine 10 may include a greater or lesser number of combustion chambers 16 and that combustion chambers 16 may be disposed in an “in-line” configuration, in a “V” configuration, in an opposing-piston configuration, in a rotary configuration, or in any other suitable configuration.

As also shown in FIG. 1, engine 10 may include a crankshaft 18 that is rotatably disposed within block 14. A connecting rod (not shown) associated with each combustion chamber 16 may connect a piston (not shown) to crankshaft 18 so that a sliding motion of each piston within the respective combustion chamber 16 results in a rotation of crankshaft 18. Similarly, a rotation of crankshaft 18 may result in a sliding motion of the pistons.

Fuel system 12 may include components that cooperate to deliver injections of pressurized fuel into each combustion chamber 16. Specifically, fuel system 12 may include a tank 20 configured to hold a supply of fuel; and a pump 22 connected to draw fuel from tank 20, to pressurize the fuel, and to direct the pressurized fuel to a plurality of fuel injectors 24 by way of a manifold 26. Pump 22 may be connected to tank 20 via a suction passage 28, and to manifold 26 via a supply passage 29. A check valve 30 may be disposed within suction passage 28, if desired. Manifold 26 may be connected to tank 20 via a return passage 34.

Pump 22 may be connected with crankshaft 18 in any manner readily apparent to one skilled in the art, where a rotation of crankshaft 18 will result in a corresponding rotation of a pump driveshaft. For example, pump 22 is shown in FIG. 1 as being connected to crankshaft 18 through a gear train. It is contemplated, however, that pump 22 may alternatively be driven electrically, hydraulically, pneumatically, or in another appropriate manner.

Fuel injectors 24 may be disposed within cylinder heads (not shown) of engine 10, and sequentially fluidly connected to manifold 26. Fuel injectors 24 may be directly connected to manifold 26 such that all of the fuel flowing through manifold 26 also flows through each individual injector 24 or, alternatively, fuel injectors 24 may be connected to common manifold 26 by a plurality of individual fuel lines 32. Each fuel injector 24 may be operable to inject an amount of pressurized fuel into an associated combustion chamber 16 at predetermined timings, fuel pressures, and quantities. The timing of fuel injection into combustion chamber 16 may be synchronized with the motion of the corresponding piston (not shown) reciprocatingly disposed therein. In the depicted embodiment, fuel injectors 24 are mechanical unit injectors (MUI injectors). It is contemplated, however that fuel injectors 24 could alternatively embody mechanically-actuated, electronically-controlled unit injectors (MEUI injectors); hydraulically actuated, electronically-controlled unit injectors (HEUI injectors); or any other type of fuel injectors known in the art.

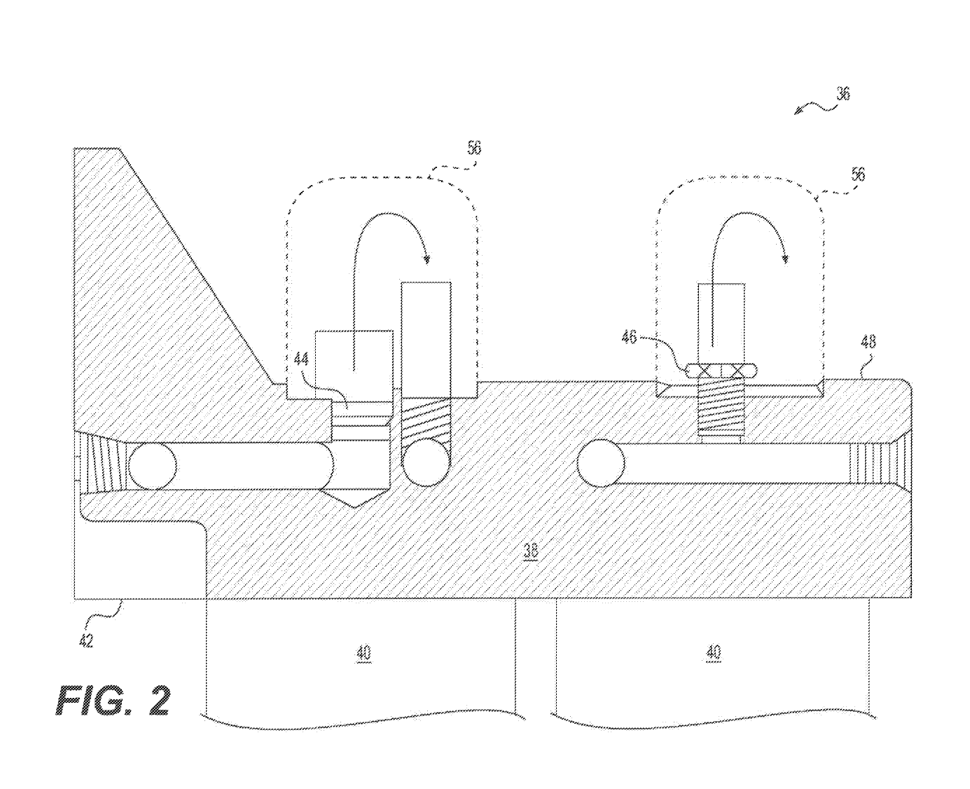

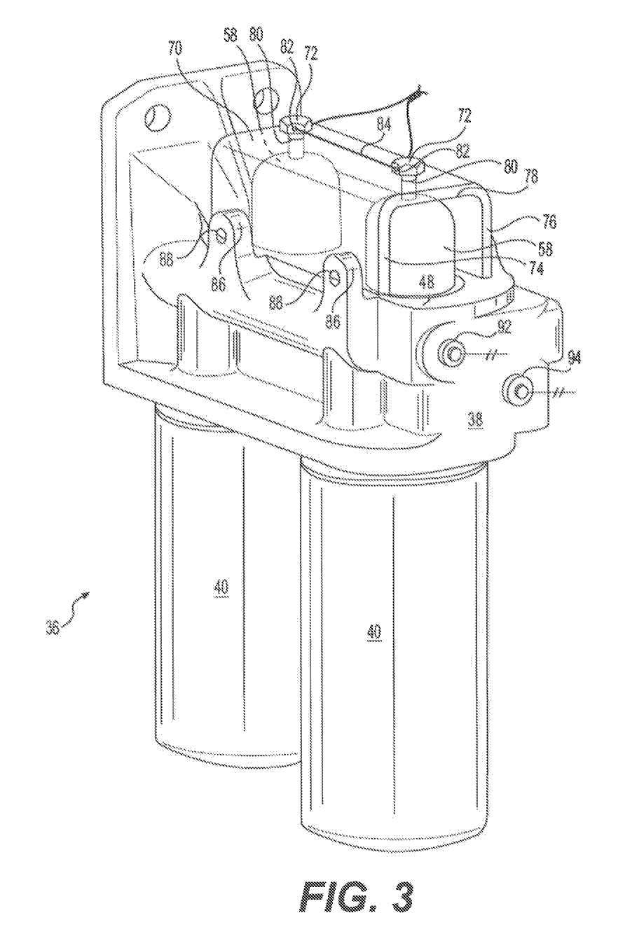

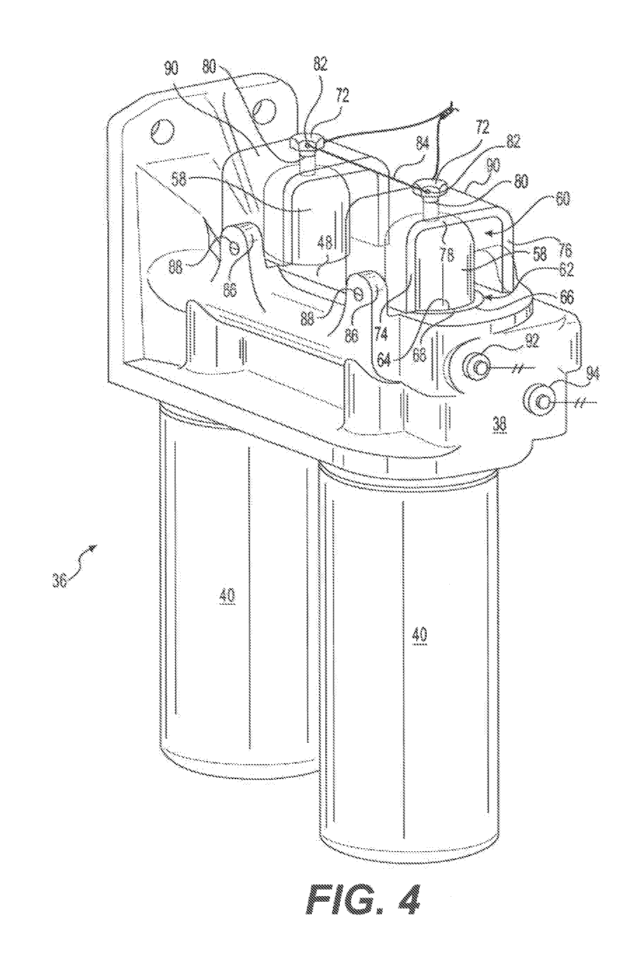

A filter assembly 36 may be plumbed between pump 22 and manifold 26, and also between manifold 26 and tank 20. As shown schematically in FIG. 2 and physically in FIGS. 3 and 4, filter assembly 36 may include a base 38, and one or more canister filters (filters) 40 hanging from a lower side 42 of base 38. First and second check valves 44, 46 may be mounted to an upper side 48 of base 38 opposite filters 40. During normal operation (e.g., when filters 40 are not plugged), pressurized fuel from pump 22 may flow into base 38 and split via a pair of branch passages 50 into two parallel flows that pass through filters 40. The separate flows may then recombine within base 38 and be discharged as a single flow to manifold 26.

During abnormal conditions, for example when plugging of one or more of filters 40 creates a restriction to the flow through branch passages 50, a fuel pressure inside base 38 may rise. This high-pressure fuel, in addition to communicating with filters 40, may also be directed to check valve 46 via a bypass passage 52. When the fuel pressure exceeds an opening pressure of check valve 46 (e.g., about 60 psi), check valve 46 may open and allow the fuel to pass back to tank 20 via return passage 34.

Check valve 44 may be in communication with return passage 34 (e.g., via a passage 54 formed in base 38), and function as a priming valve. In particular, during startup of pump 22, check valve 44 may remain closed, allowing the fuel pumped into manifold 26 to build in pressure. When manifold 26 has been adequately filled with fuel, and the fuel therein reaches a desired operating pressure (e.g., about 5 psi or higher), check valve 44 may open and allow excess fuel and air to pass from return passage 34 through passage 54 to tank 20. Thus, during normal operation of fuel system 12, some fuel should continuously be passing through check valve 44.

In earlier iterations of fuel system 12, sight glasses 56 (shown as dashed lines only in FIG. 2) were disposed over check valves 44 and 46, and formed portions of passages 52 and 54. In particular, after the fuel was discharged from check valves 44, 46, the fuel exited base 38 and entered into an interior space of sight glasses 56. This fuel then passed from sight glasses 56 back into base 38 to continue its flow through passages 52 and 54. In this way, the fuel being discharged from check valves 44 and 46 could be visible to an operator of engine 10. For example, when filters 40 were plugged, fuel would have been visible within the sight glass 56 covering valve 46; and when manifold 26 was filled and properly pressurized, fuel would have been visible within the sight glass 56 covering valve 44. Thus, during normal operation, fuel should only have been visible within the one sight glass 56 covering valve 44 (i.e., the sight glass 56 covering valve 46 should normally have been empty, as long as filters 40 were not plugged). However, for reasons stated above, sight glasses 56 are no longer utilized in the disclosed embodiments.

In the disclosed embodiments, sight glasses 56 have been replaced with metallic valve covers (covers) 58 (shown only in FIGS. 3 and 4). Like the previously used sight glasses 56, covers 58 may have a dome shape, with a closed end 60 and an open end 62. A lip 64 may be formed at open end 62 that is received within a machined recess 66 of base 38. A seal (e.g., a gasket) 68 may be disposed in recess 66 and sandwiched between lip 64 and the internal face of recess 66. In some embodiments, lip 64 may have a circular-lay roughness of about 100-150 μinch (e.g., about 125 μinch), which may help lip 64 engage with seal 68 to create a fuel-tight interface.

In the disclosed embodiment, the closed end 60 of each cover 58 is spherical. It is contemplated, however, that the closed end could alternatively be flat, such that cover 58 has more of a cylindrical shape than a domed shape, if desired. Other shapes may also be possible. Cover 58 may be fabricated from a non-corrosive metal, for example stainless steel or aluminum, through a deep-draw process.

A retainer 70 may pass over the closed end 60 of cover 58 and, together with a fastener 72, function to press cover 58 against seal 68. In the embodiment shown in FIG. 3, a single retainer 70 is used in conjunction with two covers 58. Retainer 70 may be formed from a generally C-shaped channel that extends lengthwise past the centers of each cover 58. In particular, retainer 70 may include a first side 74 connected to base 38 at one edge of cover 58, a second side 76 connected to base 38 at a second edge opposite first side 74, and a third side 78 that extends between first and second sides 74, 76. Each of first and second sides 74 and 76 may be oriented generally perpendicular to third side 78.

A threaded hole 80 may be formed within third side 78 of retainer 70, at a location generally aligned with the center of each cover 58. Fastener 72 may engage threaded hole 80, such that rotation of fastener 72 extends a shaft portion of fastener 72 inward through retainer 70 and against the center of the corresponding cover 58. With this configuration, further rotation of fastener 72 may cause fastener 72 to engage the center of cover 58 and urge cover 58 against seal 68. In some embodiments, cover 58 may be recessed at fastener 72 to receive a tip of fastener 72.

In order for retainer 70 to properly anchor fastener 72 and withstand vibrational loading during operation of engine 10, retainer 70 must have a minimum thickness at third side 78. In the disclosed embodiment, the thickness of third side 78 may be at least two-times a wall thickness of cover 58. For example, the thickness of third side 78 may be about 0.25 inch, while the wall thickness of cover 58 may be about 0.12 inch. The three-sided, generally orthogonal shape of retainer 70 may help to increase a stiffness of retainer 70 that further helps retainer 70 to resist damage caused by the vibrational loading. It is contemplated that additional internal ribbing (not shown) could be formed within retainer 70, if desired, to further increase the stiffness of retainer 70.

In some applications, it may be possible for the vibrational loading of engine 10 to cause fasteners 72 to back out of hole 80. To help fasteners 72 resist this tendency, a cross-hole 82 may be formed through a head portion of each fastener 72, and a safety wire 84 may simultaneously pass through cross-holes 82 of both fasteners 72, thereby binding the rotations of fasteners 72 to each other. This binding may inhibit rotation of either fastener 72.

First and second sides 74, 76 of retainer 70 may connect to base 38 at a plurality of different anchor points. For example, four different ears or tabs 86 may be integrally formed with base 38, and extend upward from upper surface 48. Ears 86 may be located outward of first and second sides 74, 76, and arranged in pairs that are each generally aligned with one of covers 58 (e.g., the center of the corresponding cover 58). A fastener 88 may pass through each ear 86 to engage retainer 70. It is contemplated that a vibration damper (e.g., a compressive washer —not shown) may be located at the interface of ear 86 and cover 58, if desired. In this configuration, retainer 70 may be generally fixed to base 38, such that little (if any) relative pivoting occurs.

Two separate retainers 90 are used in place of retainer 70 in the embodiment of FIG. 4. Specifically, one retainer 90 is used to retain each cover 58 in place relative to base 38. Each retainer 90, like retainer 70, may be a generally 3-sided structure formed into a C-shaped channel. A length of retainer 90, however, may be less than one-half of a length of retainer 70. In addition, each retainer 90 may be connected to base 38 by way of only two ears 86 (one at each of first and second sides 74, 76). Further, a clearance may exist between upper side 48 of base 38 and lower edges of first and second sides 74, 76. With this configuration, each retainer 90 may be able to pivot independently somewhat about an axis passing through its corresponding fasteners 88. This pivoting motion may help to center fastener 72 with the center of cover 58. In addition, in some embodiments, cover 58 may be able to pivot and/or translate somewhat relative to the associated retainer 90 (or 70), if desired.

Because covers 58 are metallic, in one embodiment, they may not be translucent in the same manner that the previously-used sight glasses 56 were transparent. As a result, the proper functioning of fuel system 12 may no longer be visually apparent. For this reason, one or more sensors may be connected to base 38 and in fluid communication with the appropriate passages. For example a first pressure sensor 92 may be connected to base 38 and located in fluid communication with passage 52 (referring to FIG. 1), and a second sensor 94 may be connected to base 38 and located in fluid communication with passage 54. Each of these sensors 92, 94 may be configured to generate signals indicative of fuel pressures within the corresponding covers 58, the signals then being utilized to determine the air-free and restriction-free status of fuel system 12.

### INDUSTRIAL APPLICABILITY

The disclosed fuel system and filter assembly may be applicable to any combustion engine where reliable and continuous operation is desired. The disclosed fuel system may help to improve reliability and facilitate continuous operation by reducing a risk of component failure within the filter assembly. In particular, the disclosed filter assembly may include valve covers that are robust, and associated retainers and fasteners that have been designed to reduce and/or withstand vibrational loading of the associated engine.

It will be apparent to those skilled in the art that various modifications and variations can be made to the disclosed fuel system and filter assembly. Other embodiments will be apparent to those skilled in the art from consideration of the specification and practice of the disclosed fuel system and filter assembly. It is intended that the specification and examples be considered as exemplary only, with a true scope being indicated by the following claims and their equivalents.

What is claimed is:

1. A filter assembly, comprising:
a base having a first side and a second side opposite the first side;
a filter extending from the first side of the base;
a valve extending from the second side of the base;
a metallic cover having a closed end surrounding the valve, and an open end located adjacent the second side of the base;
a seal sandwiched between the metallic cover and the base;
a retainer connected to the base and extending over the metallic cover; and
a fastener threadingly engaged with the retainer and protruding inward to press the metallic cover toward the base.

2. The filter assembly of claim 1 wherein:
the metallic cover includes a lip located at the open end and configured to engage the seal; and
the lip has a circular-lay roughness of about 100-150 μinch.

3. The filter assembly of claim 2, wherein the lip has a circular-lay roughness of about 125 μinch.

4. The filter assembly of claim 1, wherein the metallic cover is fabricated from stainless steel.

5. The filter assembly of claim 4, wherein the metallic cover is fabricated through a deep-draw process.

6. The filter assembly of claim 1, wherein:
the retainer is pivotal relative to the base; and
the metallic cover is pivotal relative to the retainer.

7. The filter assembly of claim 1, wherein:
the valve is a first valve;
the metallic cover is a first metallic cover;
the seal is a first seal;
the fastener is a first fastener;
the filter assembly further includes:
a second valve extending from the second side of the base adjacent the first valve;
a second metallic cover having a closed end surrounding the second valve, and an open end located adjacent the second side of the base; and
a second seal sandwiched between the second metallic cover and the base;
the retainer is configured to extend over both the first and second metallic covers; and
the filter assembly further includes a second fastener threadingly engaged with the retainer and protruding inward from the retainer to press the second metallic cover toward the base.

8. The fitter assembly of claim 7, wherein:
the retainer is non-pivotal relative to the base; and
the first and second metallic covers are independently pivotal relative to the retainer.

9. The filter assembly of claim 7, wherein each of the first and second fasteners includes a head having a hole therethrough that is configured to receive a safety wire that inhibits loosening of the first and second fasteners.

10. The filter assembly of claim 1, wherein the valve is a check valve configured to allow fluid flow through the check valve into an open area inside the metallic cover.

11. The filter assembly of claim 1, wherein a thickness of the retainer at the fastener is at least two times a wall thickness of the metallic cover.

12. The filter assembly of claim 1, further including a sensor mounted to the base and configured to generate a signal indicative of a pressure inside the metallic cover.

13. A filter assembly, comprising:
a base having a first side and a second side opposite the first side;
a filter extending from the first side of the base;
a valve extending from the second side of the base;
a cover having a closed end surrounding the valve, and an open end located adjacent the second side of the base;
a seal sandwiched between the cover and the base;
a retainer having first and second sides connected to the base, and a third side extending over the cover between the first and second sides, wherein the first, second, and third sides form a generally C-shaped channel; and
a fastener threadingly engaged with the third side of the retainer and protruding inward to press the cover toward the base.

14. The filter assembly of claim 13, wherein:
the cover includes a lip located at the open end and configured to engage the seal; and
the lip has a circular-lay roughness of about 125 μinch.

15. The filter assembly of claim 13, wherein:
the retainer is pivotal relative to the base; and
the cover is pivotal relative to the retainer.

16. The filter assembly of claim 13, wherein:
the valve is a first valve;
the cover is a first cover;
the seal is a first seal;
the fastener is a first fastener;
the filter assembly further includes:
a second valve extending from the second side of the base adjacent the first valve;
a second cover having a closed end surrounding the second valve, and an open end located adjacent the second side of the base; and
a second seal sandwiched between the second cover and the base;
the retainer is configured to extend over both the first and second covers; and
the filter assembly further includes a second fastener threadingly engaged with the retainer and protruding inward from the retainer to press the second cover toward the base.

17. The filter assembly of claim 16, wherein:
the retainer is non-pivotal relative to the base; and
the first and second covers are independently pivotal relative to the retainer.

18. The filter assembly of claim 13, wherein a thickness of the third side of the retainer is at least two times a wall thickness of the cover.

19. The filter assembly of claim 13, further including a sensor mounted to the base and configured to generate a signal indicative of a pressure inside the cover.

20. A fuel system, comprising:
a tank;
a pump connected to draw fuel from the tank;
a plurality of fuel injectors;
a manifold connecting the pump to the plurality of fuel injectors; and
a filter assembly disposed between the pump and the manifold, the filter assembly including:
a base having a first side and a second side opposite the first side;
a filter extending from the first side of the base;
a first valve extending from the second side of the base;
a second valve located adjacent the first valve and extending from the second side of the base;
a first metallic cover having a closed end surrounding the first valve, and an open end located adjacent the second side of the base;
a second metallic cover having a closed end surrounding the second valve, and an open end located adjacent the second side of the base;
a seal sandwiched between each of the first and second metallic covers and the base;
a first retainer having first and second sides connected to the base, and a third side extending over the first metallic cover between the first and second sides, wherein the first, second, and third sides form a first generally C-shaped channel;
a second retainer having first and second sides connected to the base, and a third side extending over the second metallic cover between the first and second sides, wherein the first, second, and third sides form a second generally C-shaped channel;
a first fastener threadingly engaged with the third side of the first retainer and protruding inward to press the first metallic cover toward the base;
a second fastener threadingly engaged with the third side of the second retainer and protruding inward to press the second metallic cover toward the base; and
a safety wire passing through a head of at least one of the first and second fasteners to inhibit loosening of the at least one of the first and second fasteners,
wherein:
the first and second metallic covers each includes a lip located at the open end and configured to engage the seal; and
the lip has a circular-lay roughness of about 125 μinch.
